(19) United States
(12) Patent Application Publication
(10) Pub. No.: US 2017/0306660 A1
(43) Pub. Date: Oct. 26, 2017

(54) MOTOR VEHICLE DOOR LOCK

(71) Applicant: Kiekert Aktiengesellschaft, Heiligenhaus (DE)

(72) Inventor: Frank Zimmermann, Neustadt/Wied (DE)

(21) Appl. No.: 15/516,188

(22) PCT Filed: Oct. 1, 2015
(86) PCT No.: PCT/DE2015/000478

§ 371 Date: Mar. 31, 2017

(30) Foreign Application Priority Data
Oct. 1, 2014 (DE) 10 2014 114 260.8

(51) Int. Cl. E05B 79/02; E05B 85/02; E05B 77/02

(52) U.S. Cl. CPC E05B 79/02; E05B 77/02; E05B 85/02

(57) ABSTRACT

The invention relates to a method for producing a motor vehicle door lock and to said motor vehicle door lock, comprising a locking mechanism and a lock case (1) for indirectly mounting the locking mechanism, the material thickness (D) of the lock case (1), at least in the region of the mounting (14, 15) of the locking mechanism parts, being adaptable to the forces to be absorbed, and preferably having a greater material thickness (D2).

The invention relates to a motor vehicle door latch with at least one locking mechanism and one latch case for indirect accommodation of the locking mechanism.

Motor vehicle door latches are used in lateral doors, tailgates and/or sliding doors. The task of the motor vehicle door latch is on the one hand to keep the door and/or flap closed and on the other hand to ensure that the doors do not open independently in the case of accident. Especially in relation to safety aspects, the crucial components for closure of modern motor vehicles are made of metallic materials. A catch and a pawl can be stated as crucial components here, for example, which close the motor vehicle door latch in one- or two-step ratchet closures. In order to be able to feed sufficient force into this locking mechanism, the components forming the locking mechanism, the catch and the pawl, are pivotably mounted on metallic axes and preferably on a metal bearing, the latch case. The joint purpose of latch cases, axes and the locking mechanism is to close the motor vehicle door and to keep the door closed in the case of accident, for example. The locking mechanism or the motor vehicle door latch interacts with a latch holder for closure which is preferably attached to a motor vehicle chassis. Naturally, the motor vehicle door latch can also be attached to the motor vehicle chassis and the latch holder can be mounted to the moving door, flap or sliding door.

In order to be able to absorb the great forces occurring during a crash or accident, the locking mechanism, the axes and the latch case must demonstrate sufficient stability. Known, modern calculation procedures, such as the finite element procedure, are used to design the necessary stabilities. Using this calculation procedure, the suitable material and/or material strength of the components used of the motor vehicle door latch can be selected. The stated components of a motor vehicle door latch are preferably made of steel.

In order to attain sufficient stability in a lateral door latch, it is known from DE 70 46 460 to reinforce the latch case using an additional metal sheet. A step-shaped plate which reinforces the accommodation axis of the catch or fork latch is revealed.

In order to reinforce a lateral door latch for a motor vehicle, it is known from DE 20 2011 110 393 U1 to use a reinforcement plate in the motor vehicle latch in addition to the latch case. The reinforcement plate has protruding pins which are clipped into a lateral wall of the latch case. The purpose of the reinforcement plate is to incorporate the axes of the catch and the pawl on the side opposite the latch case.

A problem posed with the current design of motor vehicle door latches is that automotive manufacturers strive to reduce vehicle weight. In relation to weight, the latch case and the locking mechanism constitute a large weight proportion. The weight proportion is in particular so large because the locking mechanism components and the latch case have to fulfill the requirements, even in extreme cases. This means that in the case of accident they need to demonstrate sufficient stability to prevent opening of the door. Sufficient material strength with sufficient stability in the highly stressed components, such as the latch case and locking mechanism, is in contrast to the requirement for a weight of the vehicle components which is as light as possible and thus also the motor vehicle latch. The invention aims to demonstrate a solution to overcome this technical problem.

The invention is based on the task of providing an improved motor vehicle door latch and in particular proposing a cost-effective, simply constructed solution to produce a latch case for a motor vehicle door latch. A particular task of the invention is to provide a latch case which fulfills the exacting requirements in extreme cases on the one hand and the requirements of the automotive industry for light weight on the other hand.

The invention is also based on the task of providing a procedure providing an improved latch case which provides the issue arising from the requirements of sufficient operating safety with simultaneously reduced weight.

The task is solved according to the invention by the characteristics of the independent claims. Advantageous designs of the invention are stated in the sub-claims. It is pointed out that the design examples described below are not restrictive; instead, any variation options are possible to the characteristics described in the description and the sub-claims.

In accordance with patent claim 1, the task of the invention is solved by a motor vehicle door latch with at least one pawl and one latch case being provided for indirect accommodation of the frame, whereby the material strength of the latch case can be adjusted to the forces to be absorbed at least in the accommodation area of the locking components and preferably has a greater material strength. Due to the formation of a latch case according to the invention with material strengths of different thicknesses in the accommodation area of the locking mechanism components, there is now the possibility of fulfilling the requirements of sufficient stability of the motor vehicle door latch on the one hand and considerably reducing the weight of the motor vehicle door latch on the other hand. An adjustment of the material strength of the latch case thus occurs to the extent that the areas in which great forces need to be absorbed have a great material thickness and areas which need to absorb lesser forces have reduced material thickness.

Latch cases of motor vehicle door latches are usually executed in a material thickness of approximately 2 mm. 2 mm thickness from metallic materials and in particular latch cases made of steel possess sufficient stability characteristics to fulfill the requirements even in extreme situations. In the less stressed areas of the latch case, a lesser material thickness can be used according to the invention. Consequently, a considerable weight reduction of the latch case can be attained. However, in order to attain sufficient stability in turn in the relevantly greatly stressed areas of the latch case, the latch case is partially formed with a different material thickness.

In one design example of the invention, the latch case is formed as a single component, at least in the accommodation area. A single-component formation of a latch case offers the advantage of not needing to insert any additional components and/or reinforcers for accommodation of the locking components. On the one hand, this simplifies manufacture, reduces costs and at the same time constitutes an extremely cost-effective option of enabling safe accommodation of the locking components. Safe location can be attained by the greater material thickness being manufactured directly from the material of the latch case. Consequently, no additional procedural steps are necessary for affixing of the greater material thickness to the latch case. The single-component formation thus guarantees a favorable force line course between the locking mechanism components and the latch case.

A further design example of the invention results when the greater material thickness can be attained by reshaping of the latch case. A reshaping of the latch case offers the advantage of the material used for reinforcement and increasing of the material thickness being provided directly by the latch case. During reshaping of the latch case, the area of the latch case can be used to reinforce or increase material thickness which is present in the area of the openings for incorporation of the accommodation of the locking mechanism components in the latch case. This means that on the one hand the apertures are incorporated into the latch cases which are required for incorporation of the accommodation equipment of the locking components and on the other hand the material driven out of or reshaped from the area of the aperture is used to increase material thickness. The reshaping process is preferably a cold reshaping process. However, hot reshaping can also occur.

If the greater material thickness is formed from a multi-layer construction of the base area, a further design example of the invention results. Reshaping in the shape in such a way that the material of the latch case is reshaped in such a way that the surplus material of the latch case from insertion of the passage aperture is folded offers the advantage that greater material thickness can be attained in the accommodation area of the locking components with the simplest reshaping techniques. Furthermore, reshaping offers the advantage of material hardenings occurring which have a positive effect on the bearing location, especially when steels are used. Hardenings occur, as generally known, from dislocation creeping during reshaping in the steel structure. Thus, on the one hand, a greater material thickness is available to incorporate greater forces and on the other hand the accommodation area offers great stability in relation to extreme stresses. Furthermore, the reshaping process offers the advantage of the geometry of the aperture attained during reshaping or refolding of the material having a beneficial impact on the mounting of the accommodation equipment. Contrary to stamping, where sharp-edged tearing points and material deformation occurs which reduces the contact ratio of the aperture or the diameter, the aperture inserted into the latch case can provide a large contact ratio in relation to the length of the aperture through the latch case.

In a further design example, the base area of the latch case has a material thickness of 0.8 mm to 1.5 mm, preferably 1 mm. The significant reduction in material thickness of the latch case in relation to the known latch cases with thicknesses of approximately 2 mm means that a considerable weight reduction can be attained by means of the design according to the invention. On the one hand, the weight is reduced; however, material is saved simultaneously and thus cost savings are made in the manufacture of the latch case or the latch plate. Here it is once again explicitly stated that the terms “latch case” and “latch plate” are used as synonyms, whereby latch case and latch plate both describe a component of the motor vehicle door latch manufactured from a metallic material which serves to incorporate the locking mechanism components.

Even if the locking mechanism components are described here which are of crucial importance for a tensile test or in the case of a crash, it is naturally also possible to attach other components to the latch case according to the invention. If, as proposed, a material thickness of 1 mm, for example, is selected for the latch case, with a one-time transfer of the material of the latch case a material thickness of the latch case of 2 mm can be attained. Even if here preferably as also in the design example a one-time transfer of the material in the accommodation area of the locking mechanism components is described, according to the invention it is thus also imaginable that the latch case comprises one, two or three layers in the accommodation area of the locking mechanism components. The number of layers in the accommodation area is dependent on the selected material thickness of the latch case and also the necessary tensile forces which need to be attained to correspond to the requirements of the motor vehicle door latch. If a material thickness of 0.8 mm is selected, the weight of the latch plate can be reduced by more than 50%.

A further design example results if the base area of the latch case has an indent in the accommodation area. An area which is formed offset in parallel to the base area of the latch case is called an indent. If the height of the indent deep-drawing corresponds to the material thickness of the latch case, an even surface can be attained when reshaping is complete. If the height of the indent deep-drawing is less than the material thickness, a surface preferably protruding via the latch case can be attained.

The necessary area is deep drawn by the desired depth. The expansion of the indent can correspond to exactly the size which corresponds to the reshaped area of the greater material thickness. Consequently, a flush surface can be attained. However, it is also conceivable to form the offset area to be larger than the area to be reshaped if, for example, the reshaped area or the embossed area should act as a contact surface for a functional component in the motor vehicle latch.

A further advantageous design of the invention results when the height of the indent corresponds to the material thickness of the latch case. Consequently, a surface flush with the latch case and a surface protruding via the latch case can be attained. If, advantageously, the indent is designed in such a way that the offset surface corresponds to a material thickness of the latch plate or the latch case, it is thus possible for the embossed area to form a flush surface with the latch case. This is especially advantageous if the embossed area should act as a contact surface simultaneously, for example in relation to a motor vehicle chassis. If, additionally, the offset area is selected in its dimensions in such a way that the offset area corresponds to exactly the area which forms the greater material thickness due to reshaping, an almost uninterrupted contact surface can be simultaneously formed for a functional component or a screw mounting surface. In this context, screw mounting surface means that the embossed area is applied on an internal surface of a lateral door or tailgate for mounting, for example, within the scope of mounting of the motor vehicle latch. If an embossed area is referred to here, this means the area which forms a layer or an additional layer in relation to the base area of the latch case by means of reshaping. The embossed area then forms the reshaped area.

If the flush surface or the surface protruding via the latch case forms a contact surface for a functional component, especially a catch or a pawl, a further design example of the invention results. The area of the latch case is preferably reshaped and formed with a greater material thickness by the catch or a pawl being arranged in the latch case. The locking mechanism components are exposed to extreme stresses in the case of accident or during the test phase in a tensile test. The locking mechanism consisting of a catch and a pawl interacts with a latch holder which is preferably but not compulsorily attached to the chassis of the motor vehicle.

If now in the case of an accident or during a tensile test an increased load or force is exerted on the motor vehicle latch, great stresses occur which act between the catch and the latch holder. These extreme stresses are transferred to the latch case via absorption means, especially a rotational axis. The latch case is directly screwed to the door or tailgate and becomes the support and the supporting element for stable and safe positioning of the locking mechanism under these extreme stresses. Under these extreme conditions, the areas of the latch case are also subject to extreme stresses which are absorbed by the locking mechanism components. It can thus be helpful and it forms an design example of the invention when the locking mechanism components are either opposite a flush surface or lie opposite defined surfaces to reduce frictional forces, for example. According to the formed embossed area and size of the contact area or the indent a defined firmness can thus be designed in the latch case which corresponds to the requirements of the motor vehicle latch. It is to be understood that in the case of deployment of the motor vehicle latch in a lateral door other stresses occur as can be found, for example, in a motor vehicle latch in the tailgate area.

From a procedural perspective, the task of the invention is solved by a procedure being provided to manufacture a latch case for a motor vehicle latch in which an opening is molded in the latch case by means of initial reshaping and the reshaped material is subsequently embossed to form a multi-layer construction in the area of the opening. The procedure according to the invention provides a procedure in which the material thickness of the latch case can be reduced overall. A reduction of the material thickness of the latch case offers the advantage of reducing the weight of the motor vehicle latch which, in turn, has a positive effect on the weight of the motor vehicle latch. A cost reduction also occurs simultaneously. By reducing the material thickness, an advantage can be attained in relation to the procedure simultaneously. Thinner materials can be reshaped more easily and simultaneously offer the option of being able to attain sufficient firmness characteristics due to their multi-layer nature.

In an initial reshaping process, which is preferably deep-drawing, an aperture is molded into the latch case which can then act as an accommodation point for the locking mechanism components. During reshaping or deep-drawing to form the aperture in the latch case, materials are re-shaped but not removed from the latch case. This re-shaped material overhang can then be used in a subsequent further reshaping process which is advantageously a shaping to form a multi-layer construction. An embossed area is formed in which a multi-layer formation of the latch case is present which corresponds to the embossed area.

The procedure according to the invention can be improved by an indent being formed in the latch case in the area of the opening, whereby the indent has at least a surface corresponding to the multi-layer construction. If an indent is additionally molded into the latch case, a flush surface can be formed with the latch case on the one hand, whereby the embossed area can form a flush surface with the latch case. However, it is not vital for the indent to form a flush surface with the latch case, the indent can also be executed in such a way that the embossed area lies below the plane of the latch case or the other way round in such a way that the embossed area juts out beyond the latch case. All alternatives, the protrusion, the flush formation or the deep-drawing of the embossed area in relation to the surface of the latch case offer individual advantages which can be used according to the individual application.

The invention is described in further detail below with reference to the attached drawings on the basis of the preferred design examples. However, the principle applies that the design example does not limit the invention, but only constitutes an advantageous design example. The characteristics depicted can be executed individually or in combination, individually or in combination with other characteristics of the description, as also the patent claims.

The following are shown:

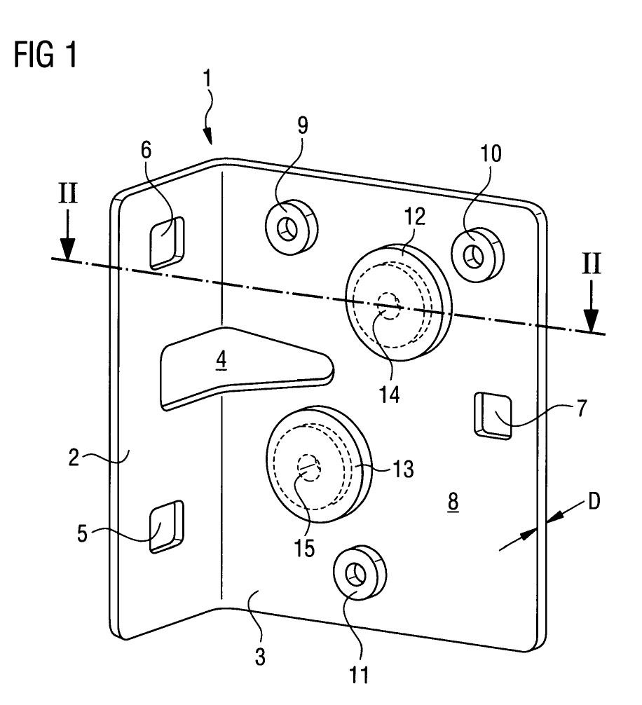

FIG. 1 a three-dimensional view of a latch case without a latch housing,

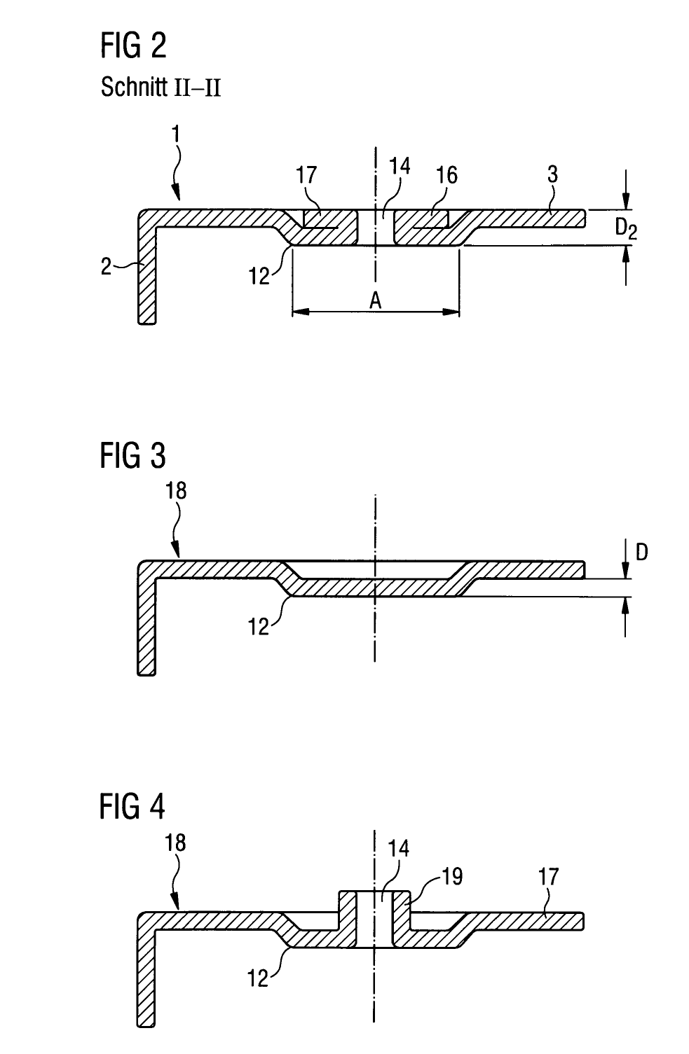

FIG. 2 a profile according to line II-II through the latch case formed according to the invention according to FIG. 1,

FIG. 3 a latch case as a semi-finished product, also in an area of an indent of the latch case, and

FIG. 4 the semi-finished product according to FIG. 3 after to a further procedural step.

A latch case 1 is represented in a three-dimensional view in FIG. 1. The latch case 1 is L-shaped and has a short leg 2 and a long leg 3. Naturally, the latch case 1 can also be O-shaped, so that a non-illustrated latch housing is surrounded on three sides. Starting from the short leg 2 an infeed section 4 is formed which extends into the long leg 3. The infeed section 4 accommodates the latch holder. Consequently, a latch holder which is also not illustrated can interact with a locking mechanism. In addition, openings 5, 6, 7 are provided in the latch case 1 which attach the latch case 1 to the latch housing, whereby the latch case can be connected to the latch housing with, for example, clip connections. Starting from an internal side 8 of the latch case 1, threaded bushings 9, 10, 11 are formed on the latch case 1. The threaded bushings 9, 10, 11 attach the latch case and the motor vehicle latch to the motor vehicle. The threaded bushings 9, 10, 11 can also be formed according to the invention by means of reshaping, whereby subsequently threads are cut into the bushings 9, 10, 11. In order to accommodate the non-illustrated catch and pawl, indents 12, 13 are molded into the latch case 1. Apertures 14, 15 are provided for in the indents 12, 13 to accommodate the locking mechanism components. The latch case 1 has a uniform material thickness D which extends via the long leg 3 and the short leg 2.

A profile according to line II-II from FIG. 1 is reproduced in FIG. 2. In the accommodation area 14 the reshaping forms an embossed area 16, which forms a flush surface 17 with the latch case 1 in this design example. The indent 12 and the embossed area 16 demonstrate greater material thickness D2 which corresponds to double the material thickness of the latch case 1 in the present design example. As is apparent from FIG. 1 and FIG. 2, the indent 12 has an indent diameter A which extends beyond the embossed area 16. However, according to the invention it is also possible that the embossed area 16 and the indent diameter A demonstrate a uniform size so that an almost closed flush surface 17 of the latch case is formed. It is also clearly apparent from FIG. 2 that the accommodation area 14 has an almost uniform diameter over the entire extent of the accommodation area 14. Consequently, a higher contact ratio is provided for the accommodation area 14.

The design example according to FIG. 2 shows the embossed area in a direction opposite the short leg 2. It is naturally also possible to form the embossed area 16 in the direction of the short leg 2. If no indent 12 is inserted into the latch case 1 here, the embossed area 16 forms an elevation which forms an elevation of material thickness D over the material thickness D of the latch case. By selecting the diameter of the indent A and/or the size of the embossed area 16 it is thus possible to provide different contact surfaces according to the arrangement of the embossed area 16 to the locking mechanism or also other functional components.

In FIG. 3, a semi-finished product 18 is illustrated which forms a starting component for manufacture of a latch case 1 according to FIG. 1. An indent 12 corresponding in its depth to the material thickness D of the latch case 1 is molded into the semi-finished product 18 and preferably molded by means of deep-drawing which.

FIG. 4 shows the semi-finished product 18 after a further reshaping process, whereby an accommodation area 14 was molded into the semi-finished product 18 using deep-drawing. The reshaping process caused a material overhang 19 to occur which protrudes over the flush surface 17 of the semi-finished product 18. In a further deformation step the material overhang 18 is then embossed or folded over. Consequently, a latch case according to FIG. 2 is formed.

### LIST OF REFERENCES

Latch case 1
Short leg 2
Long leg 3
Infeed section 4
Opening 5, 6, 7
Internal side 8
Threaded bushings 9, 10, 11
Indent 12, 13
Aperture, accommodation area 14, 15
Embossed area 16
Flush surface 17
Semi-finished product 18
Material overhang 19
Material thickness D
Thickness D2
Indent diameter A

1. A motor vehicle door latch with at least one locking mechanism and a latch case for indirect accommodation of the locking mechanism, wherein the material thickness of the latch case is adjustable at least in accommodation area of the locking mechanism components to the forces to be absorbed and preferably has greater material thickness.

2. The motor vehicle door latch according to claim 1, wherein the latch case is formed as a single component, at least in the accommodation area.

3. The motor vehicle door latch according to claim 1, wherein the greater material thickness can be attained by means of a reshaping of the latch case.

4. The motor vehicle door latch according to claim 1, wherein the greater material thickness is formed from a multi-layer construction of a base area of the latch case.

5. The motor vehicle door latch according to claim 1, wherein the base area of the latch case has a material thickness of 0.8 mm to 1.5 mm, preferably 1 mm.

6. The motor vehicle door latch according to claim 1, wherein the base area of the latch case has an indent in the accommodation area.

7. The motor vehicle door latch according to claim 6, wherein the height of the indent corresponds to the material thickness of the latch case, so that preferably a surface flush with the latch case and a surface protruding beyond the latch case can be attained.

8. The motor vehicle door latch according to claim 7, wherein the flush surface or the surface protruding via the latch case forms a contact area for a functional component, in particular a catch or a pawl.

9. A procedure for production of a latch case for a motor vehicle latch, in which an opening is molded in the latch case by means of initial reshaping and the reshaped material is then embossed for formation of a multi-layer construction in the opening area.

10. A procedure according to claim 9, wherein the opening area an indent is molded into the latch case, whereby the indent has at least a surface corresponding to the multi-layer construction.
